(19) United States
(12) Patent Application Publication
(10) Pub. No.: US 2018/0003035 A1
(43) Pub. Date: Jan. 4, 2018

(54) SYSTEM AND METHOD FOR DOWNHOLE SENSING

(71) Applicant: General Electric Company, Schenectady, NY (US)

(72) Inventors: Richard Luht, Oklahoma City, OK (US); Dewey Lavonne Parkey, JR., Oklahoma City, OK (US); Xuele Qi, Oklahoma City, OK (US); Yi Liao, Oklahoma City, OK (US); Stewart Brazil, Oklahoma City, OK (US); Vimal Shah, Sugar Land, TX (US)

(21) Appl. No.: 15/196,192

(22) Filed: Jun. 29, 2016

(51) Int. Cl. E21B 47/10; E21B 47/06; G01N 9/00; H04B 1/02

(52) U.S. Cl. CPC E21B 47/10; H04B 1/02; E21B 47/06; E21B 47/065; G01N 9/00

(57) ABSTRACT

A downhole sensing system includes a casing connector configured to fluidly couple segments of a downhole conduit through which a fluid flows. The downhole sensing system includes a sensing device disposed in the casing connector and configured to measure one or more parameters. The downhole sensing system also includes a wireless communication device disposed in the casing connector and configured to wirelessly communicate one or more parameters.

### FIELD

The subject matter described herein relates to systems and methods for sensing in subterraneous environments.

### BACKGROUND

Downhole systems are regularly used in order to extract resources from subterranean reservoirs. Downhole conduit systems comprise a vertical and horizontal well sections that run generally vertical and parallel to the ground surface.

In certain current systems, sensors are disposed in production tubing that is fed into the vertical well section. One challenge in disposing sensors in production tubing is that the sensors are unable to reach the horizontal well section of the downhole conduit system, thereby limiting a part of the downhole conduit system from being monitored. Additionally, disposing sensors on production tubing can be expensive. For example, sections of the production tubing may need to be replaced when sensors fail.

To increase the extraction of fluids, downhole conduit systems limit structural blockage to the extent feasible. In order to avoid restriction of the fluid that flows through the downhole conduit system, current sensor solutions may be limited in size. But, due to these size limitations, current solutions lack the energy capacity to provide long-term monitoring. Batteries or other power supply devices assembled with the sensor monitors, lack the capacity to provide long-term power due to the size restriction of the sensors.

Additionally, current solutions rely on fiber optic cables to communicate measured data from the downhole conduit system to the surface. One challenge with fiber optic cables is sustaining the integrity and stability of the fiber-optic cables within the downhole conduit system.

Another challenge is that cable costs increase for downhole systems that extend a long distance. Additionally, deploying a long cable system to a downhole system, specifically to the horizontal well section, is difficult and costly.

### BRIEF DESCRIPTION

In one embodiment, a downhole sensing system comprising a casing connector is configured to fluidly couple segments of a downhole conduit through which a fluid flows. The downhole sensing system comprises a sensing device disposed in the casing connector and is configured to measure one or more parameters. And a wireless communication device is disposed in the casing connector and is configured to wirelessly communicate one or more parameters.

In one embodiment, a downhole sensing system comprises a casing connector configured to fluidly couple segments of a downhole conduit through which fluid flows. The downhole sensing system comprises a sensing device disposed in the casing connector and is configured to measure one or more parameters of the fluid flowing through the downhole conduit. The sensing device is configured to be powered by one or more batteries or an energy harvesting device disposed in the casing connector. And a wireless communication device is disposed in the casing connector to wirelessly communicate one or more measured parameters.

In one embodiment, a method comprises moving an energy harvesting device into a deployed state within a casing connector of a downhole sensing system. The method comprises measuring one or more parameters of a fluid flowing through a downhole conduit with a sensing device disposed in the casing connector. And wirelessly communicating the one or more parameters with a wireless communication device disposed in the casing connector.

### BRIEF DESCRIPTION OF THE DRAWINGS

The present inventive subject matter will be better understood from reading the following description of non-limiting embodiments, with reference to the attached drawings, wherein below:

FIG. 1 illustrates one embodiment of a wellbore system;

FIG. 2 illustrates one embodiment of a downhole sensing system;

FIG. 3A illustrates one embodiment of a linkage system in a retracted state;

FIG. 3B illustrates one embodiment of a linkage system in a deployed state;

FIG. 4A illustrates a cross sectional view of a linkage system in a retracted state in accordance with one embodiment;

FIG. 4B illustrates a cross sectional view of a linkage system in a deployed state in accordance with one embodiment; and

FIG. 5 illustrates a flowchart of a method of operation of the downhole sensing system in accordance with one embodiment.

### DETAILED DESCRIPTION

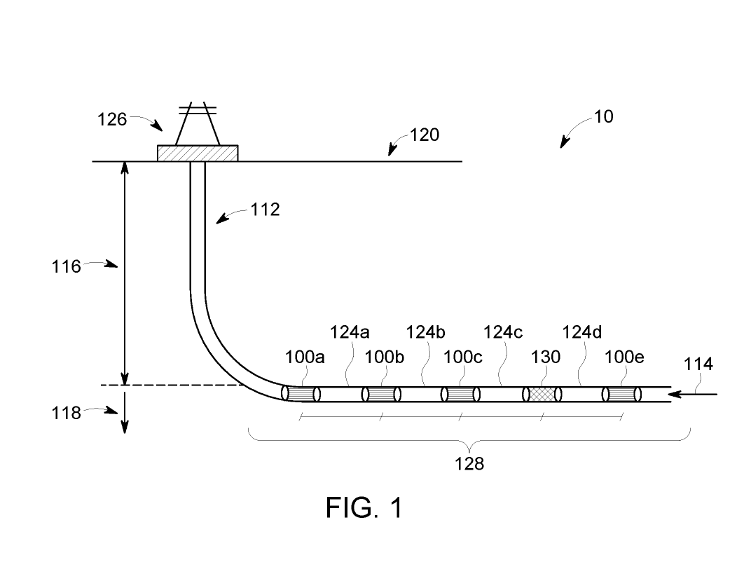

FIG. 1 illustrates a wellbore system 10 in accordance with one embodiment. The wellbore system 10 may be used for hydraulic fracturing for the retrieval of resources (e.g., natural gas, petroleum, and the like) from subterranean locations. The wellbore system 10 may extract fluids from a location below a surface 120. Additionally or alternatively, the wellbore system 10 may convey fluids to a location below the surface 120. The wellbore system 10 comprises a downhole conduit 112. The downhole conduit 112 extends through at least one vertical well section 116 to at least one horizontal well section 118. The vertical well section 112 defines a length of the downhole conduit 112 that extends generally vertically below the surface 120. The horizontal well section 118 defines a length of the downhole conduit 112 that extends generally horizontal to and below the surface 120.

The downhole conduit 112 positioned within the horizontal well section 118 comprises a horizontal casing string 128. The horizontal casing string 128 comprises one or more downhole sensing systems 100 mechanically joining one or more conduit segments 124.

The downhole sensing system 100 joins two conduit segments 124 of the horizontal casing string 128. For example, the downhole sensing system 100b joins the conduit segment 124b to the conduit segment 124a. A downhole sensing system may be positioned between two conduit segments 124. Additionally or alternatively, a connector 130 may be positioned between two conduit segments 124. For example, the horizontal casing string 128 may comprise a single downhole sensing system 100a and one or more connectors 130 to join the conduit segments 124. Optionally, the horizontal casing string 128 may comprise a number of downhole sensing systems 100 to join the conduit segments 124. The one or more downhole sensing systems 100 may be positioned a distance apart relative to the length of the conduit segment 124. For example, a first downhole sensing systems 100 may be positioned a distance 500 ft. apart from a second downhole sensing system 100. Additionally or alternatively, the first downhole sensing system 100 may be positioned a distance less than 500 ft. apart from the second downhole sensing system 100. Optionally, the first downhole sensing system 100 may be positioned a distance greater than 500 ft. apart from the second downhole sensing system 100.

A fluid flows through the horizontal casing string in a direction designated by an arrow 114. For example, the fluid flows in the direction 114 from a location beneath the surface 120, through the horizontal casing string 128 of the downhole conduit 112, to a surface wellhead 126. Additionally or alternatively, the wellbore system 10 may pump a fluid from the surface 120 through the downhole conduit 112 in a direction opposite the arrow 114. Optionally, the wellbore system 10 may feed a cable system down into the downhole conduit 112 (not shown). For example, a data cable may be used to connect the downhole system 100a (e.g., the downhole system closest to the vertical well section 116) to the surface wellhead 126. Fluids and the like, may travel through the interior of the downhole conduit 112 in direction 114, or a direction opposite the direction 114.

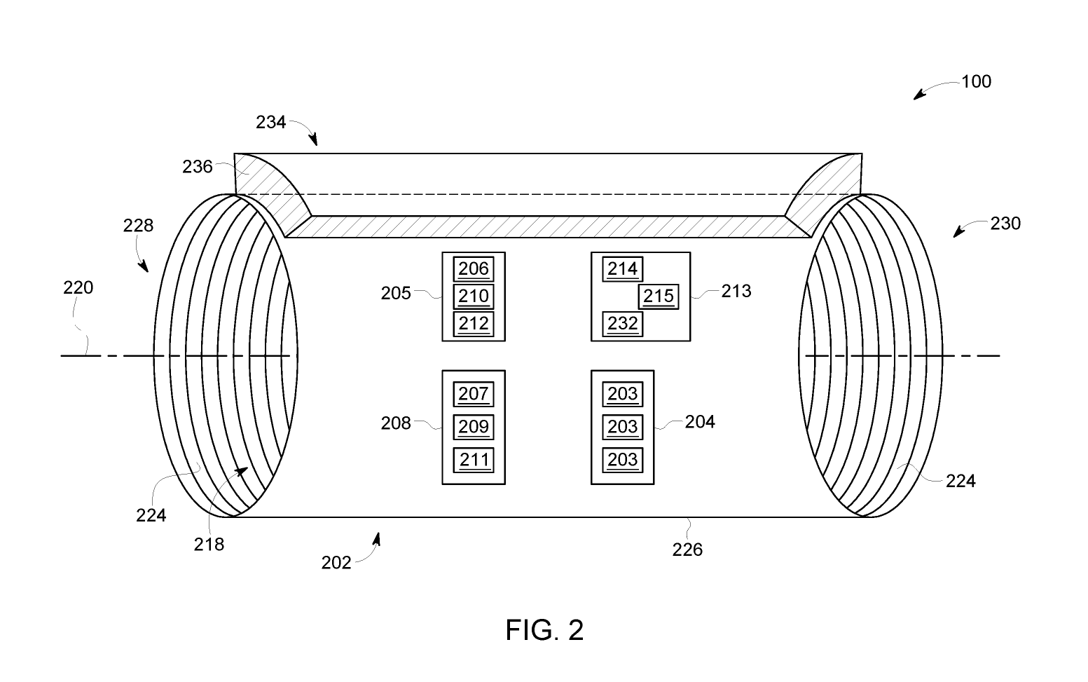

FIG. 2 illustrates one embodiment of the downhole sensing system 100. The downhole sensing system 100 comprises a casing connector 202 that is elongated about a longitudinal axis 220. The casing connector is generally circular in shape about the longitudinal axis 220. The casing connector 202 is hollow with an interior surface 218 and an exterior surface 226. The casing connector 202 is sized and shaped to receive conduit segments 124 of the downhole conduit 112 at a first end 228 and a second end 230 of the casing connector 202. Additionally or alternatively, the casing connector may be of any other cross sectional shape.

The first end 228 and the second end 230 of the casing connector 202 comprise threads 224 that are a complimentary shape to a threaded end of the conduit segments 124 (not shown). For example, the first end 228 is joined to a conduit segment by the complimentary threads. Additionally or alternatively, the first end 228 and the second end 230 of the casing connector 202 may be joined to the conduit segment by alternative joining means.

The casing connector 202 has one or more connector ribs 234. The one or more connector ribs 234 are positioned on the exterior surface 226 of the casing connector 202 and extend axially away from the exterior surface 226. The one or more connector ribs 234 extend along the longitudinal axis 220. For example, the one or more connector ribs 234 may extend from the first end 228 to the second end 230 of the casing connector 202 along the longitudinal axis 220. The one or more connector ribs 234 has a hollow interior pocket 236. The interior pocket 236 may extend along the length of the connector rib 234. Optionally, the hollow interior pocket 236 may only extend a partial length of the connector rib 234. For example, the hollow interior pocket 236 may be hollow only along a partial length of the connector rib 234. The one or more connector ribs 234 are tapered about the longitudinal axis 220. Optionally, the connector ribs 234 may be an alternative shape. For example, the connector rib 234 may be spiraled about the longitudinal axis 220 in order to assist insertion of the downhole sensing system 100 into the downhole conduit 112.

The downhole sensing system 100 includes a sensing device 204. The sensing device 204 includes one or more sensors 203 configured to measure one or more properties of the fluid and/or the wellbore integrity. The sensing device 204 is disposed on the interior surface 218 of the casing connector 202. For example, the sensing device 204 is positioned on the interior surface 218 in order for the sensing device 204 to be in contact with the fluid flowing through the downhole conduit 112. Optionally, the sensing device 204 may be inbedded between the interior surface 218 and the exterior surface 226. For example, the sensing device 204 may be a temperature sensor that does not need to be exposed to the fluid that flows through the downhole sensing system in order to read the temperature of the fluid and/or the downhole sensing system 100.

The sensing device 204 measures one or more parameters of the fluid that flows through the downhole conduit 112. For example, the sensing device 204 may measure one or more of a temperature of the fluid, pressure, a phase of the flow (e.g., the phase of a gas, oil, or water), density of the fluid, and the like. The sensing device 204 continuously measures one or more parameters of the fluid that flows through the downhole conduit 112. Additionally or alternatively, the sensing device 204 may measure one or more parameters of the fluid when the fluid flows in the direction 114 (of FIG. 1) through the downhole conduit 112. Optionally, the sensing device 204 may measure one or more parameters of the fluid when the fluid flows in the direction opposite direction 114 (of FIG. 1) through the downhole conduit 112. Additionally or alternatively, the sensing device 204 may measure one or more properties of the formation, casing, or wellbore integrity of the downhole conduit 112. For example, the sensing device 204 may measure one or more properties that define a state of the downhole conduit 112. For example, the sensing device may measure a crack within the casing connector 202 of the downhole conduit 112 to determine the integrity of the casing connector in order to prevent failures.

The downhole sensing system 100 has a wireless communication device 213. The sensing device 204 may be operably connected with the wireless communication device 213. The wireless communication device 213 is disposed in the casing connector 202 of the downhole sensing system 100. The wireless communication device 213 may represent one or more transducers or receivers. For example, the wireless communication device 213 may be acoustic transducers or electromagnetic antennas.

The wireless communication device comprises a data transmitter 215, a data receiver 214, and a control circuit 232. The wireless communication device 213 may also comprise only one data transmitter 215 and a control circuit 232. The data transmitter 215 communicates data to a second downhole sensing system 100 of the horizontal casing string 128. For example, the data transmitter 215 may transmit the one or more sensed parameters to a second downhole sensing system. Additionally or alternatively, the data transmitter 215 may communicate data to the surface wellhead 126. The data receiver 214 receives data from one or more downhole sensing systems. Additionally or alternatively, the data receiver 214 may receive data from the surface wellhead 126. The control circuit 232 can represent hardware circuitry that includes and/or is connectors with one or more processors (e.g., microprocessors, filed programmable gate arrays, or integrated circuits). The control circuit 232 may control operations of the wireless communication device 213. For example, the control circuit 232 may represent the hardware and/or software that controls the operations of the wireless communication device 213.

The wireless communication device 213 wirelessly communicates with one or more wireless communication devices of a second downhole sensing system of the horizontal casing string 128. For example, the wireless communication device 213 may wirelessly communicate sensed data parameters to a second downhole sensing system of the horizontal casing string 128. The second downhole sensing system may wireless communicate the sensed data parameters to a third downhole sensing system of the horizontal casing string 128. For example, the downhole sensing system 100c (of FIG. 1) may communicate sensed data to the downhole sensing system 100b of the horizontal casing string 128. The downhole sensing system 100b may communicate the sensed data to the downhole sensing system 100a of the horizontal casing string 128. Optionally, the wireless communication device 213 may wirelessly communicate with a wireless communication device of the surface wellhead 126 above the surface 120.

Returning to FIG. 1, the downhole sensing system 100 positioned closest to the vertical well section 116 may also be identified as a master downhole sensing system 100a. The master downhole sensing system 100a may communicate wirelessly with the other downhole sensing systems 100b, 100c, 100d. For example, the downhole sensing system 100b receives one or more parameters wirelessly communicated by the downhole sensing system 100c. The downhole sensing system 100b then wirelessly communicates the one or more parameters to the master downhole sensing system 100a. For example, the downhole sensing system 100b repeats the one or more parameters received from the downhole sensing system 100c and wirelessly communicates the repeated one or more parameters to the master downhole sensing system 100a. The master downhole sensing system 100a comprises a master downhole wireless communication device (corresponding to the wireless communication device 213). The master wireless communication device of the master downhole sensing system 100a may then communicate the one or more parameters to the surface wellhead 126. Additionally or alternatively, the master downhole sensing system 100a may further comprise a data wire connecting the master downhole sensing system 100a to the surface wellhead 126. For example, the master downhole sensing system 100a may communicate the one or more parameters over the data wire to the surface wellhead 126.

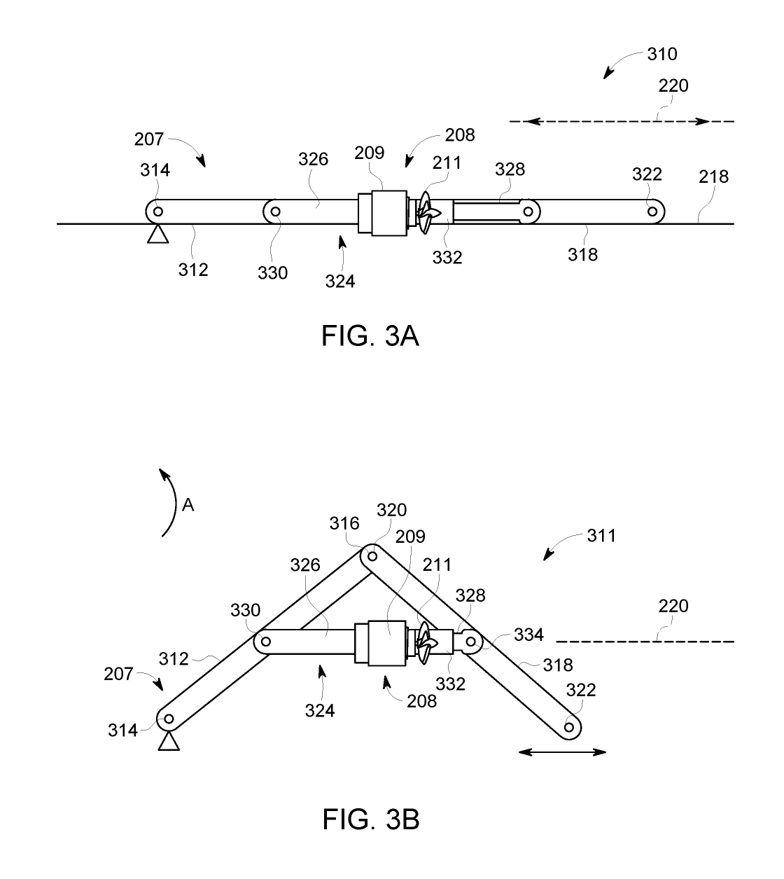

The downhole sensing system 100 has an energy harvesting device 208. The energy harvesting device 208 has one or more alternator 209 and one or more turbine 211 that are joined to a linkage system 207. The linkage system 207 will be described in more detail below with regard to FIGS. 3A and 3B. The energy harvesting device 208 harvest (e.g., extracts) energy from the flow of the fluid through the downhole conduit 112. The alternator 209 converts the mechanical energy generated by the turbine 211 that spins from the flow of fluid through the casing connector into electric energy. The energy harvesting device 208 is operably connected with the wireless communication device 213. For example, the wireless communication device 213 may wirelessly communicate to the surface wellhead 126 a state of the energy harvesting device 208. The energy harvesting device 208 is operably connected with the sensing device 204. For example, the sensing device 204 may measure the flow rate of the fluid by the spinning of the turbine 211.

The downhole sensing system 100 has an energy storage device 205. The energy storage device 205 is disposed in the casing connector 202 of the downhole sensing system 100. The energy storage device 205 comprises one or more batteries 206, one or more high temperature printed circuit boards (HT-PCB) 210, and one or more super capacitors 212. The energy storage device 205 powers the downhole sensing system 100. For example, the energy storage device 205 powers the sensor 204 and the wireless communication device 213.

The energy harvesting device 208 is operably connected with the energy storage device 205 such that the energy harvesting device 208 supplies the harvested energy from the flow of the fluid to the energy storage device 205. For example, the energy harvesting device 208 harvests energy from the flow of the fluid and supplies the harvested energy as electric current to the energy storage device 205.

The energy storage device 205 is operably connected with one or more of the sensing device 204 or the wireless communication device 213. For example, the energy storage device 205 supplies the harvested electric current energy to one or more of the sensing device 204 or the wireless communication device 213 in order to power one or more of the sensing device 204 or the wireless communication device 213. Additionally or alternatively, the energy storage device 205 supplies electric energy from the one or more batteries 206 to one or more of the sensing device 204 or the wireless communication device 213 in order to power one or more of the sensing device 204 or the wireless communication device 213.

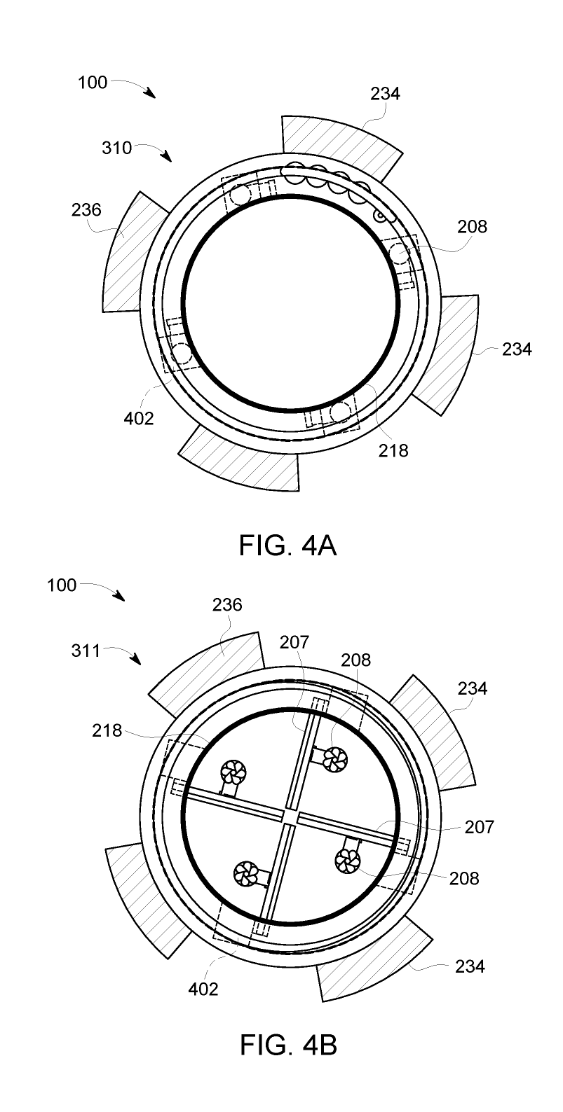

FIGS. 3A and 3B illustrate one embodiment of the linkage system 207 of the energy harvesting device 208. FIGS. 4A and 4B illustrate a cross sectional view of one embodiment of the linkage system 207 of the energy harvesting device 208. The FIGS. 3A, 3B, 4A and 4B will be discussed in detail together.

The linkage system 207 is a foldable mechanism disposed in the casing connector 202 of the downhole sensing system 100. The linkage system 207 has a fixed bar 312, a sliding bar 318, and a cross bar assembly 324. The fixed bar 312 has a pivot end 314 and a connecting end 316. The pivot end 314 of the fixed bar 312 is fixed to the interior surface 218 of the casing connector 202. The sliding bar 318 has a sliding end 322 and a connecting end 320. The connecting end 320 of the sliding bar 318 joins to the connecting end 316 of the fixed bar 312. The sliding end 322 of the sliding bar 318 slides in a direction parallel to the longitudinal axis 220 along the interior surface 218 of the casing connector 202. The cross bar assembly 324 has a fixed cross bar 326 and a sliding cross bar 328. A first end 330 of the fixed cross bar 326 is joined to the fixed bar 312 at a position between the pivot end 314 and the connecting end 316 of the fixed bar 312. A second end 332 of the fixed cross bar 326 receives the sliding cross bar 328. A first end 334 of the sliding cross bar 328 is joined to the sliding bar 318 at a position between the connecting end 320 and the sliding end 322 of the sliding bar 318.

FIG. 3A illustrates one embodiment of the linkage system 207 in a retracted state. When the linkage system 207 is in the retracted state, the fixed bar 312 and the sliding bar 318 are proximate the interior surface 218 of the casing connector 202. For example, when the linkage system is in the retracted state, the connecting ends 316, 320 are proximate the interior surface 218 of the casing connector 202 and the sliding end 322 of the sliding bar 318 is distal from the pivot end 314 of the fixed bar 312. When the linkage system moves into the retracted state, the sliding cross bar 328 telescopes out of the fixed cross bar 326. Additionally or alternatively, the sliding cross bar 328 may comprise a rail that slides along a track of the fixed cross bar 326. Optionally, the sliding cross bar 328 may be joined to and move with the fixed cross bar 326 by an alternative mechanism.

FIG. 3B illustrates one embodiment of the linkage system 207 in a deployed state. When the linkage system 207 is in the deployed state, the connecting ends 316, 320 of the fixed bar 312 and sliding bar 318 respectively are distal the interior surface 218 of the casing connector 202. For example, when the linkage system is in the deployed state, the sliding end 322 of the sliding bar 318 moves towards the pivot end 314 of the fixed bar 312. The sliding end 322 of the sliding bar 318 moving towards the pivot end 314 of the fixed bar 312 causes the connecting end 316 of the fixed bar 312 to rotate in the direction of arrow A. For example, when the linkage system moves into the deployed state, the connecting ends 316, 320 are distal the interior surface 218 of the casing connector 202. When the linkage system moves into the deployed state, the sliding cross bar 328 telescopes into the fixed cross bar 326. Additionally or alternatively, the sliding cross bar 328 may comprise a rail that slides along a track of the fixed cross bar 326. Optionally, the sliding cross bar 328 may be joined to and move with the fixed cross bar 326 by an alternative mechanism.

The alternator 209 and the turbine 211 of the energy harvesting device 208 are joined to the cross bar assembly 324 of the linkage system 207. The alternator 209 and the turbine 211 move with the cross bar assembly 324 into the retracted state and into the deployed state. For example, when the linkage system 207 is in the retracted state, the alternator 209 and the turbine 211 of the energy harvesting device 208 are located proximate the interior surface 218 of the casing connector 202. When the linkage system 207 is in the deployed state, the alternator 209 and the turbine 211 of the energy harvesting device 208 are located distal the interior surface 218 of the casing connector 202.

FIG. 4A illustrates the linkage system 207 and the energy harvesting device 208 in the retracted state. When in the retracted state, the energy harvesting device 208 is positioned proximate the interior surface 218 of the casing connector within a casing pocket 402. For example, when the linkage system 207 and the energy harvesting device 208 are in the retracted state, the energy harvesting device 208 is not positioned within the flow of the fluid through the downhole conduit 112.

FIG. 4B illustrates the linkage system 207 and the energy harvesting device 208 in the deployed state. When in the deployed state, the energy harvesting device is positioned distal the interior surface 218 of the casing connector 202. For example, when in the deployed state, the energy harvesting device 208 is positioned to be parallel with the flow direction of the fluid (direction 114 of FIG. 1). For example, when the energy harvesting device 208 is in the deployed state, the turbine 211 will spin as a result of the fluid flowing through the casing connector 202.

FIGS. 4A and 4B illustrate one embodiment of the downhole sensing system 100 comprising four energy harvesting device 208 and four linkage systems 207. Additionally or alternatively, any number of linkage systems 207 and energy harvesting devices 208 may be disposed in the downhole sensing system 100. Additionally, FIGS. 4A and 4B illustrate one embodiment of the downhole sensing system 100 comprising four connector ribs 234 and four hollow interior pockets 236. Additionally or alternatively, any number of connector ribs 234 may be disposed in the downhole sensing system 100.

The linkage system 207 may transition between the retracted state and the deployed state by commands communicated from a control processor (not shown) at the surface wellhead 126 to the control circuit 232. Optionally, the linkage system 207 may transition between the retracted and deployed states by a mechanical mechanism disposed in the casing connector. For example: the linkage system 207 may be configured with springs that transition the linkage system 207 into a preferred deployed state. Alternative mechanisms may be used in order to transition the linkage system 207 from the retracted state into the deployed state.

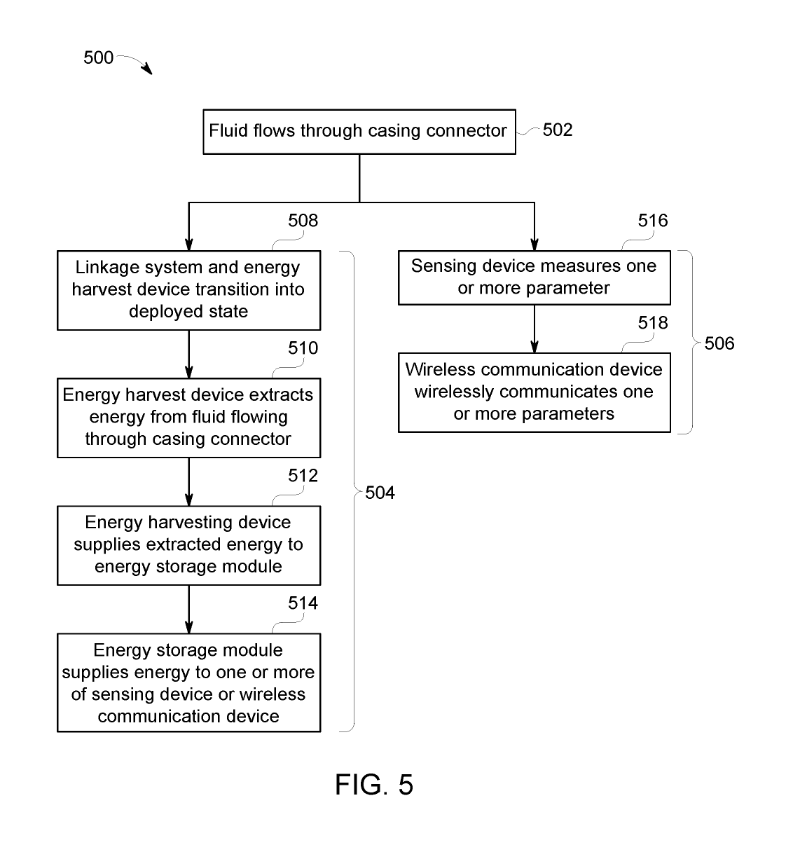

FIG. 5 illustrates a flowchart of a method 500 of operation of the downhole sensing system 100 according to one embodiment. At 502, a fluid flows through the casing connector 202 of the downhole sensing system 100 through the downhole conduit 112. For example, the fluid may flow towards the surface wellhead 126 (e.g., direction 114 of FIG. 1) or away from the surface wellhead 126 (e.g., direction opposite direction 114 of FIG. 1).

After the step 502, the method 500 splits into two simultaneous method sequences 504 and 506. The method sequence 504 illustrates the flowchart of the method of extracting energy from the flow of the fluid to use to power the downhole sensing system 100. The method sequence 506 illustrates the flowchart of the method of the sensing device 204 measuring one or more parameters of the fluid. The method sequence 504 is performed independently from the method sequence 506. The method sequence 506 is performed independently from the method sequence 504. Additionally or alternatively, both operations sequences may be performed. Additionally or alternatively, only one operation sequence may be performed.

During the method sequence 504, at 508 the linkage system 207 moves into the deployed state, thereby moving the energy harvesting device 208 into the deployed state. At 510, the energy harvesting device 208, disposed on the linkage system 207, extracts energy from the flow of the fluid through the casing connector 202. For example, the energy harvesting device 208 disposed distal the interior surface of the casing connector 202 is positioned parallel with the flow direction of the fluid. The energy harvesting device extracts energy from the flow of the fluid using the actuator 209 and turbine 211.

At 512, the energy harvesting device 208 supplies the extracted energy to the energy storage device 205 as electric current. At 514, the energy storage device 205 supplies energy in the form of electric current to one or more of the sensing device 204 or the wireless communication device 213. For example, the energy storage device 205 supplies energy in order to power the sensing device 204 and/or the wireless communication device 213. Additionally or alternatively, the energy storage device 205 may supply energy to one or more of the sensing device 204 or the wireless communication module 213 from the one or more batteries 206.

During the method sequence 506, at 516 the sensing device 204 measures one or more parameters from the fluid that flows through the casing connector 202. For example, the sensing device 204 may measure one or more of a temperature of the fluid, pressure, a phase of the flow (e.g., the phase of a gas, oil, or water), density of the fluid, and the like. The sensing device 204 is operably connected with the turbine 211 of the energy harvesting device 208. For example, the sensing device 204 may measure the flow rate of the fluid by the spinning of the turbine 211. Additionally or alternatively, the sensing device 204 may measure one or more properties of the formation, casing, or wellbore integrity of the downhole conduit 112. For example, the sensing device 204 may identify foreign material and/or objects within the casing connector 202 of the downhole conduit 112. Optionally, the sensing device 204 may identify changes to the size of the casing connector 202 in order to determine the integrity of the downhole sensing system 100.

At 518, the wireless communication device 213, disposed in the downhole sensing system 100, wirelessly communicates the one or more parameters to a second downhole sensing system 100. The wireless communication device 213 communicates the one or more parameters in a non-optical manner. For example, the downhole sensing system 100c may wirelessly communicate the one or more senses parameters to the downhole sensing system 100b.

Optionally, the wireless communication device 213 may wirelessly communicate the one or more parameters measured by the sensing device 204 by introducing pressure perturbation into the fluid flowing through the casing connector 202 of the downhole conduit 112. The pressure perturbation is representative of the one or more parameters. Optionally, the wireless communication device 213 may wirelessly communicate the one or more parameters measured by the sensing device 204 by coupling one or more of a compression wave or a shear wave of the fluid with the casing connector 202 as the fluid flows through the downhole conduit 112. The compression wave and/or the shear wave is representative of the one or more parameters. Optionally, the wireless communication device 213 may wirelessly communicate the one or more parameters measured by the sensing device 204 by introducing a surface wave into the interface between the casing connector 202 and the fluid flowing through the casing connector 202 of the downhole conduit 112. The surface wave is representative of the one or more parameters. Optionally, the wireless communication device 213 may wirelessly communicate the one or more parameters by communicating the one or more parameters via an electromagnetic field created by an electromagnetic antenna disposed in the casing connector 202. Optionally, the wireless communication device 213 may wirelessly communicate the one or more parameters by communicating the one or more parameters via a plurality of acoustic perturbations and an electromagnetic field created by an electromagnetic antenna disposed in the casing connector 202.

In one embodiment, a downhole sensing system includes a casing connector configured to fluidly couple segments of a downhole conduit through which a fluid flows. The downhole sensing system includes a sensing device disposed in the casing connector and is configured to measure one or more parameters. And a wireless communication device is disposed in the casing connector and is configured to wirelessly communicate one or more parameters.

In one example, the sensing device includes one or more sensors configured to measure one or more of a temperature, a pressure, a rate of flow, a phase of flow, or density of the fluid flowing through the casing connector.

In one example, the sensing device includes one or more sensors configured to measure one or more properties of the formation, casing or wellbore integrity.

In one example, the sensing device is powered by one or more batteries.

In one example, the sensing device is powered by one or more energy harvesting device disposed in the casing connector.

In one example, the downhole sensing system includes an energy harvesting device disposed in the casing connector and is configured to extract energy from flow of fluid through the casing connector. The energy harvesting device supplies the energy that is extracted as electric current to one or more of the sensing device or the wireless communication device to power the one or more of the sensing device or the wireless communication device.

In one example, the wireless communication device is configured to wirelessly communicate the one or more parameters in a non-optical manner.

In one example, the wireless communication device is configured to wirelessly communicate the one or more parameters by introducing pressure perturbation into the fluid flowing inside the casing connector and the downhole conduit, the pressure perturbation representative of the one or more parameters.

In one example, the wireless communication device is configured to wirelessly communicate the one or more parameters by coupling one or more of a compressional wave or a shear wave with the casing connector and the downhole conduit, the one or more of compressional wave or shear wave representative of the one or more parameters.

In one example, the wireless communication device is configured to wirelessly communicate the one or more parameters by introducing a surface wave into the interface between the casing connector and fluid flowing through the casing connector, the surface wave representative of the one or more parameters.

In one example, the wireless communication device is configured to wirelessly communicate the one or more parameters by communicating the one or more parameters via electromagnetic field created by an electromagnetic antenna disposed in the casing connector.

In one example, the wireless communication device is configured to wirelessly communicate the one or more parameters by communicating the one or more parameters via a plurality of acoustic perturbations and electromagnetic field created by an electromagnetic antenna disposed in the casing connector.

In one example, the wireless communication device is one of plural wireless communication devices disposed at different locations along a length of the downhole conduit. The wireless communication devices are configured to wirelessly communicate the one or more parameters to one or more other wireless communication devices or a master wireless communication device and the one or more other wireless communication devices are configured to repeat the one or more parameters to one or more additional wireless communication devices.

In one example, a master wireless communication device is configured to wirelessly communicate the one or more parameters from a downhole location beneath a surface to a computing device disposed above the surface by one or more of wirelessly or through a data cable connected to surface wellhead.

In one example, the casing connector includes an interior surface, and further comprises a linkage system operably coupled with an energy harvesting device and the sensing device, wherein the linkage system is configured to move between a retracted state and a deployed state inside the casing connector. When in the retracted state, the linkage system is configured to move the energy harvesting device and the sensing device closer to the interior surface of the casing connector relative to the deployed state, and when in the deployed state, the linkage system is configured to move the energy harvesting device and the sensing device farther from the interior surface of the casing connector relative to the retracted state.

In one embodiment, a downhole sensing system includes a casing connector configured to fluidly couple segments of a downhole conduit through which fluid flows. The downhole sensing system comprises a sensing device disposed in the casing connector and is configured to measure one or more parameters of the fluid flowing through the downhole conduit. The sensing device is configured to be powered by one or more batteries or an energy harvesting device disposed in the casing connector. And a wireless communication device is disposed in the casing connector to wirelessly communicate one or more measured parameters.

In one example, the sensing device includes one or more sensors configured to measure one or more of a temperature, a pressure, a rate of flow, a phase of flow, or density of the fluid flowing through the casing connector.

In one example, the sensing device includes one or more sensors configured to measure one or more properties of the formation, casing, or wellbore integrity.

In one example, the wireless communication device is configured to wirelessly communicate the one or more parameters in a non-optical manner.

In one example, the wireless communication device is one of plural wireless communication devices disposed at different locations along a length of the downhole conduit. The wireless communication devices are configured to wirelessly communicate the one or more parameters to one or more other wireless communication devices or a master wireless communication device and the one or more other wireless communication devices are configured to repeat the one or more parameters to one or more additional wireless communication devices.

In one example, the casing connector includes an interior surface, and further comprising a linkage system operably coupled with an energy harvesting device and the sensing device, wherein the linkage system is configured to move between a retracted state and a deployed state inside the casing connector. When in the retracted state, the linkage system is configured to move the energy harvesting device and the sensing device closer to the interior surface of the casing connector relative to the deployed state. When in the deployed state, the linkage system is configured to move the energy harvesting device and the sensing device farther from the interior surface of the casing connector relative to the retracted state.

In one embodiment, a method includes moving an energy harvesting device into a deployed state within a casing connector of a downhole sensing system. The method comprises measuring one or more parameters of a fluid flowing through a downhole conduit with a sensing device disposed in the casing connector. And wirelessly communicating the one or more parameters with a wireless communication device disposed in the casing connector.

In one example, the method also includes measuring one or more of a temperature, a pressure, a rate of flow, a phase of flow, or density of the fluid flowing through the casing connector.

In one example, the method also includes extracting energy from flow of the fluid through the casing connector and supplying the energy as electric current to one or more of the sensing device or the wireless communication device to power the one or more of the sensing device or the wireless communication device.

In one example, the method also includes wirelessly communicating the one or more parameters in a non-optical manner.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A downhole sensing system comprising:
a casing connector configured to fluidly couple segments of a downhole conduit through which a fluid flows;
a sensing device disposed in the casing connector and configured to measure one or more parameters; and
a wireless communication device disposed in the casing connector and configured to wirelessly communicate one or more parameters.

2. The downhole sensing system of claim 1, wherein the sensing device includes one or more sensors configured to measure one or more of a temperature, a pressure, a rate of flow, a phase of flow, or density of the fluid flowing through the casing connector.

3. The downhole sensing system of claim 1, wherein the sensing device includes one or more sensors configured to measure one or more properties of the formation, casing or wellbore integrity.

4. The downhole sensing system of claim 1, wherein the sensing device is powered by one or more batteries.

5. The downhole sensing system of claim 1, wherein the sensing device is powered by one or more energy harvesting device disposed in the casing connector.

6. The downhole sensing system of claim 1, further comprising an energy harvesting device disposed in the casing connector and configured to extract energy from flow of the fluid through the casing connector and to supply the energy that is extracted as electric current to one or more of the sensing device or the wireless communication device to power the one or more of the sensing device or the wireless communication device.

7. The downhole sensing system of claim 1, wherein the wireless communication device is configured to wirelessly communicate the one or more parameters in a non-optical manner.

8. The downhole sensing system of claim 1, wherein the wireless communication device is configured to wirelessly communicate the one or more parameters by introducing pressure perturbation into the fluid flowing inside the casing connector and the downhole conduit, the pressure perturbation representative of the one or more parameters.

9. The downhole sensing system of claim 1, wherein the wireless communication device is configured to wirelessly communicate the one or more parameters by coupling one or more of a compressional wave or a shear wave with the casing connector and the downhole conduit, the one or more of compressional wave or shear wave representative of the one or more parameters.

10. The downhole sensing system of claim 1, wherein the wireless communication device is configured to wirelessly communicate the one or more parameters by introducing a surface wave into the interface between the casing connector and fluid flowing through the casing connector, the surface wave representative of the one or more parameters.

11. The downhole sensing system of claim 1, wherein the wireless communication device is configured to wirelessly communicate the one or more parameters by communicating the one or more parameters via electromagnetic field created by an electromagnetic antenna disposed in the casing connector.

12. The downhole sensing system of claim 1, wherein the wireless communication device is configured to wirelessly communicate the one or more parameters by communicating the one or more parameters via a plurality of acoustic perturbations and electromagnetic field created by an electromagnetic antenna disposed in the casing connector.

13. The downhole sensing system of claim 1, wherein the wireless communication device is one of plural wireless communication devices disposed at different locations along a length of the downhole conduit, and wherein the wireless communication devices are configured to wirelessly communicate the one or more parameters to one or more other wireless communication devices or a master wireless communication device and the one or more other wireless communication devices are configured to repeat the one or more parameters to one or more additional wireless communication devices.

14. The downhole sensing system of claim 1, wherein a master wireless communication device is configured to wirelessly communicate the one or more parameters from a downhole location beneath a surface to a computing device disposed above the surface by one or more of wirelessly or through a data cable connected to surface wellhead.

15. The downhole sensing system of claim 1, wherein the casing connector includes an interior surface, and further comprising a linkage system operably coupled with an energy harvesting device and the sensing device, wherein the linkage system is configured to move between a retracted state and a deployed state inside the casing connector,
wherein, in the retracted state, the linkage system is configured to move the energy harvesting device and the sensing device closer to the interior surface of the casing connector relative to the deployed state, and
wherein, in the deployed state, the linkage system is configured to move the energy harvesting device and the sensing device farther from the interior surface of the casing connector relative to the retracted state.

16. A downhole sensing system comprising:
a casing connector configured to fluidly couple segments of a downhole conduit through which fluid flows;
a sensing device disposed in the casing connector and configured to measure one or more parameters of the fluid flowing through the downhole conduit, wherein the sensing device configured to be powered by one or more of one or more batteries or an energy harvesting device disposed in the casing connector; and
a wireless communication device disposed in the casing connector to wirelessly communicate one or more measured parameters.

17. The downhole sensing system of claim 16, wherein the sensing device includes one or more sensors configured to measure one or more of a temperature, a pressure, a rate of flow, a phase of flow, or density of the fluid flowing through the casing connector.

18. The downhole sensing system of claim 16, wherein the sensing device includes one or more sensors configured to measure one or more properties of the formation, casing, or wellbore integrity.

19. The downhole sensing system of claim 16, wherein the wireless communication device is configured to wirelessly communicate the one or more parameters in a non-optical manner.

20. The downhole sensing system of claim 16, wherein the wireless communication device is one of plural wireless communication devices disposed at different locations along a length of the downhole conduit, and wherein the wireless communication devices are configured to wirelessly communicate the one or more parameters to one or more other wireless communication devices or a master wireless communication device and the one or more other wireless communication devices are configured to repeat the one or more parameters to one or more additional wireless communication devices.

21. The downhole sensing system of claim 16, wherein the casing connector includes an interior surface, and further comprising a linkage system operably coupled with an energy harvesting device and the sensing device, wherein the linkage system is configured to move between a retracted state and a deployed state inside the casing connector,
wherein, in the retracted state, the linkage system is configured to move the energy harvesting device and the sensing device closer to the interior surface of the casing connector relative to the deployed state, and
wherein, in the deployed state, the linkage system is configured to move the energy harvesting device and the sensing device farther from the interior surface of the casing connector relative to the retracted state.

22. A method comprising:
Moving an energy harvesting device into a deployed state within a casing connector of a downhole sensing system;
Measuring one or more parameters of a fluid flowing through a downhole conduit with a sensing device disposed in the casing connector; and
Wirelessly communicating the one or more parameters with a wireless communication device disposed in the casing connector.

23. The method of claim 22, further comprising measuring one or more of a temperature, a pressure, a rate of flow, a phase of flow, or density of the fluid flowing through the casing connector.

24. The method of claim 22, further comprising extracting energy from flow of the fluid through the casing connector and supplying the energy as electric current to one or more of the sensing device or the wireless communication device to power the one or more of the sensing device or the wireless communication device.

25. The method of claim 22, further comprising wirelessly communicating the one or more parameters in a non-optical manner.
